(19) United States
(12) Patent Application Publication
(10) Pub. No.: US 2023/0257616 A1
(43) Pub. Date: Aug. 17, 2023

(54) RHEOLOGY-MODIFYING DIFUNCTIONAL COMPOUND

(71) Applicant: COATEX, Genay (FR)

(72) Inventors: Yves MATTER, Reyrieux (FR); Denis RUHLMANN, Genay (FR); Jean-Marc SUAU, Lucenay (FR)

(73) Assignee: COATEX, Genay (FR)

(21) Appl. No.: 18/005,133

(22) PCT Filed: Jul. 26, 2021
(86) PCT No.: PCT/FR2021/000083

§ 371 Date: Jan. 11, 2023

(30) Foreign Application Priority Data
Jul. 27, 2020 (FR) FR2007892

(51) Int. Cl. C09D 125/14; C09D 17/00; C09D 7/43; C09D 5/02

(52) U.S. Cl. CPC C09D 125/14; C09D 17/001; C09D 7/43; C09D 5/024

(57) ABSTRACT

A difunctional compound T prepared by reacting one molar equivalent of at least one dihalogenated compound (a), and two molar equivalents of a same polyalkoxylated compound (b) selected from the group consisting of straight aliphatic monoalcohols (b1), branched aliphatic monoalcohols (b2), cycloaliphatic monoalcohols (b3), monoaromatic monoalcohols (b4), and polyaromatic monoalcohols (b5).

The invention relates to a rheology-modifying difunctional compound. The invention also provides an aqueous composition comprising a difunctional compound according to the invention and a method for controlling the viscosity of an aqueous composition using the difunctional compound according to the invention.

In general, for aqueous coating compositions, and in particular for aqueous paint or varnish compositions, it is necessary to control the viscosity both for low or medium shear gradients and for high shear gradients. Indeed, during its preparation, storage, application or drying, a paint formulation is subjected to numerous stresses requiring particularly complex rheological properties.

When paint is stored, the pigment particles tend to settle by gravity. Stabilising the dispersion of these pigment particles therefore requires a paint formulation with high viscosity at very low shear gradients corresponding to the limiting velocity of the particles. Paint uptake is the amount of paint taken up by an application tool such as, for example, a paintbrush, a brush or a roller. If the tool takes up a large amount of paint when dipped into and removed from the can, it will not need to be dipped as often. Paint uptake increases as the viscosity increases. The calculation of the equivalent shear gradient is a function of the paint flow velocity for a particular thickness of paint on the tool. The paint formulation should therefore also have a high viscosity at low or medium shear gradients.

Moreover, the paint must have a high filling property so that, when applied to a substrate, a thick coat of paint is deposited at each stroke. A high filling property therefore makes it possible to obtain a thicker wet film of paint with each stroke of the tool. The paint formulation must therefore have a high viscosity at high shear gradients.

High viscosity at high shear gradients will also reduce or eliminate the risk of splattering or dripping when the paint is being applied.

Reduced viscosity at low or medium shear gradients will also result in a neat, taut appearance after the paint has been applied, particularly a single-coat paint, to a substrate which will then have a very even surface finish with no bumps or indentations. The final visual appearance of the dry coat is thus greatly improved.

Furthermore, once the paint has been applied to a surface, especially a vertical surface, it should not run. The paint formulation thus needs to have a high viscosity at low and medium shear gradients.

Lastly, once the paint has been applied to a surface, it should have a high levelling capacity. The paint formulation must then have a reduced viscosity at low and medium shear gradients.

Documents WO 9631550 and KR20180070923 describe poly(acetal-polyether) compounds prepared from a dibrominated compound and from a polyol. Document JPS54022308 discloses certain compounds prepared by reacting halides and polyethylene glycol derivatives. Document JPH11228686 discloses certain compounds prepared by reacting halides and aromatic compounds.

HEUR (hydrophobically modified ethoxylated urethane)-type compounds are known as rheology-modifying agents.

However, the known HEUR-type compounds do not always make it possible to provide a satisfactory solution. In particular, the rheology-modifying compounds of the prior art do not always allow for effective viscosity control or do not always achieve a satisfactory improvement in the compromise between Stormer viscosity (measured at low or medium shear gradients and expressed in KUs) and ICI viscosity (measured at high or very high shear gradients and expressed in s⁻¹). In particular, the known rheology-modifying compounds do not always make it possible to increase the ICI viscosity/Stormer viscosity ratio.

There is therefore a need for improved rheology-modifying agents. The difunctional compound according to the invention makes it possible to provide a solution to all or part of the problems of the rheology-modifying agents in the prior art.

Thus, the invention provides a difunctional compound T prepared by reacting:
a. one molar equivalent of at least one dihalogenated compound (a) of formula (I):

L-R₂ (I)

wherein R independently represents Cl, Br or I and L independently represents a CH₂ group and
b. two molar equivalents of a same polyalkoxylated compound (b) chosen among:
   straight aliphatic monoalcohols (b1) comprising from 6 to 40 polyalkoxylated carbon atoms comprising from 80 to 500 alkoxylated groups,
   branched aliphatic monoalcohols (b2) comprising from 6 to polyalkoxylated carbon atoms comprising from 80 to 500 alkoxylated groups,
   cycloaliphatic monoalcohols (b3) comprising from 6 to 40 polyalkoxylated carbon atoms comprising from 80 to 500 alkoxylated groups,
   monoaromatic monoalcohols (b4) comprising from 6 to 30 polyalkoxylated carbon atoms comprising from 80 to 500 alkoxylated groups,
   polyaromatic monoalcohols (b5) comprising from 10 to 80 polyalkoxylated carbon atoms comprising from 80 to 500 alkoxylated groups.

Essentially according to the invention, the difunctional compound T is prepared from at least one compound (a) comprising two halogen atoms and from a compound (b) capable of reacting with these halogen atoms and comprising a saturated, unsaturated or aromatic hydrocarbon chain combined with a polyalkoxylated chain. Preferably according to the invention, this reagent compound (b) is a monohydroxylated compound.

Preferably according to the invention, the condensation of compounds (a) and (b) is carried out in the presence of a catalyst, in particular a basic catalyst. This catalyst may be chosen among strong bases such as KOH, NaOH.

Preferably according to the invention, the reaction uses a single compound (a) or the reaction uses two or three different compounds (a).

According to the invention, the dihalogenated compound (a) comprises on average 2 halogen groups. Generally, the dihalogenated compound (a) comprises on average 2±mol % of halogen groups.

Preferably according to the invention, compound (a) is a compound of formula (I) wherein R independently represents Br or I, preferably Br. More preferably according to the invention, compound (a) is chosen among dibromomethane, diiodomethane and combinations thereof.

According to the invention, the monoalcohols are compounds comprising a single hydroxyl (OH) group that is terminal. According to the invention, the polyalkoxylated monoalcohols are compounds comprising a hydrocarbon chain that comprises several alkoxylated groups and a terminal hydroxyl (OH) group. According to the invention, the polyalkoxylated monoalcohols are compounds of formula Q-(LO)ₙ—H wherein Q represents a hydrocarbon chain, n represents the number of polyalkoxylations and L, identical or different, independently represents a straight or branched alkylene group comprising from 1 to 4 carbon atoms. According to the invention, the non-alkoxylated monoalcohols are compounds comprising a hydrocarbon chain and a single hydroxyl (OH) group that is terminal. According to the invention, the non-alkoxylated monoalcohols are compounds of formula Q′-OH wherein Q′ represents a hydrocarbon chain. According to the invention, the number of carbon atoms defining monoalcohols (b1) to (b5) therefore corresponds to the number of carbon atoms in the Q or Q′ groups.

Preferably according to the invention, the polyalkoxylated monoalcohols comprise from 100 to 500 alkoxylated groups, preferably from 80 to 400 alkoxylated groups or from 100 to 200 alkoxylated groups. Also preferably according to the invention, the alkoxylated groups are chosen among oxyethylene (—CH₂CH₂O—), oxypropylene (—CH₂CH(CH₃)O— or —CH(CH₃)CH₂O—), oxybutylene (—CH(CH₂CH₃)CH₂O— or —CH₂CH(CH₂CH₃)O—) and combinations thereof. More preferably, the alkoxylated groups are oxyethylene groups alone or combined with oxypropylene groups; in particular the molar amount of oxypropylene groups is comprised between 1 and 30%. Much more preferably, the alkoxylated groups are oxyethylene groups.

Essentially according to the invention, compound T is a compound comprising alkoxylated groups. Preferentially according to the invention, compound T has a degree of polyalkoxylation comprised between 100 and 500 or between 100 and 502. The degree of polyalkoxylation defines the number of alkoxylated groups included in this compound, in particular oxyethylene, oxypropylene or oxybutylene groups.

Preferably according to the invention, compound (b) is such that:
the hydrocarbon chain of monoalcohol (b1) comprises from 6 to 30 carbon atoms, preferably from 6 to 20 carbon atoms or from 8 to 16 carbon atoms, more preferentially monoalcohol (b1) is chosen among polyalkoxylated n-octanol, polyalkoxylated n-decanol, polyalkoxylated n-dodecanol, polyalkoxylated n-hexadecanol, or
the hydrocarbon chain of monoalcohol (b2) comprises from 6 to 30 carbon atoms, preferably from 6 to 20 carbon atoms or from 8 to 16 carbon atoms, more preferentially, monoalcohol (b2) is chosen among polyalkoxylated ethylhexanol, polyalkoxylated isooctanol, polyalkoxylated isononanol, polyalkoxylated isodecanol, polyalkoxylated propyl heptanol, polyalkoxylated butyl octanol, polyalkoxylated isododecanol, polyalkoxylated isohexadecanol, a polyalkoxylated oxo alcohol, a polyalkoxylated Guerbet alcohol, or
the hydrocarbon chain of monoalcohol (b3) comprises from 6 to 30 carbon atoms, preferably from 6 to 20 carbon atoms or from 8 to 20 carbon atoms, more preferentially monoalcohol (b3) is chosen among polyalkoxylated ethylcyclohexanol, polyalkoxylated n-nonyl-cyclohexanol, polyalkoxylated n-dodecyl-cyclohexanol, or
the hydrocarbon chain of monoalcohol (b4) comprises from 12 to 30 carbon atoms or from 12 to 22 carbon atoms, preferably monoalcohol (b4) is chosen among polyalkoxylated n-pentadecyl-phenol or
the hydrocarbon chain of monoalcohol (b5) comprises from 10 to 60 carbon atoms, preferably monoalcohol (b5) is chosen among polyalkoxylated naphthol, polyalkoxylated distyrylphenol, polyalkoxylated tristyrylphenol, polyalkoxylated pentastyrylcumylphenol.

Essentially according to the invention, the compound T is prepared using a monoalcohol and in the absence of diol or of triol or in the absence of any compound comprising at least two hydroxyl (OH) groups.

In addition to a difunctional compound T, the invention also relates to a method for preparing this compound.

Thus, the invention provides a method for preparing a difunctional compound T by reacting:
a. one molar equivalent of at least one dihalogenated compound (a) of formula (I):

L-R₂ (I)

wherein R independently represents Cl, Br or I and L independently represents a CH₂ group and
b. two molar equivalents of a same polyalkoxylated compound (b) chosen among:
   straight aliphatic monoalcohols (b1) comprising from 6 to 40 polyalkoxylated carbon atoms comprising from 80 to 500 alkoxylated groups,
   branched aliphatic monoalcohols (b2) comprising from 6 to polyalkoxylated carbon atoms comprising from 80 to 500 alkoxylated groups,
   cycloaliphatic monoalcohols (b3) comprising from 6 to 40 polyalkoxylated carbon atoms comprising from 80 to 500 alkoxylated groups,
   monoaromatic monoalcohols (b4) comprising from 6 to 30 polyalkoxylated carbon atoms comprising from 80 to 500 alkoxylated groups,
   polyaromatic monoalcohols (b5) comprising from 10 to 80 polyalkoxylated carbon atoms comprising from 80 to 500 alkoxylated groups.

Preferably according to the invention for the preparation method according to the invention, the condensation of compounds (a) and (b) is carried out in the presence of a catalyst, in particular a basic catalyst. This catalyst may be chosen among strong bases such as KOH, NaOH.

Advantageously according to the invention, the condensation of compounds (a) and (b) is carried out in an organic solvent. The preferred organic solvents are solvents that are non-reactant with the halogen atoms of compound (a), in particular the solvents chosen among the hydrocarbon solvents (particularly C₈ to C₃₀ petroleum cuts), the aromatic solvents (particularly toluene and its derivatives) and combinations thereof. More preferably according to the invention, condensation is carried out directly with the different reagents or is carried out in toluene.

At the end of the preparation of the compound T according to the invention, a solution of the compound in an organic solvent is obtained. Such a solution can be used directly. Also according to the invention, the organic solvent can be separated and the compound T dried.

Such a compound T according to the invention, which is dried, can then be used in solid form, for example in powder or pellet form.

In addition to the difunctional compound T and a method for preparing this compound, the invention also relates to an aqueous composition comprising at least one difunctional compound T according to the invention. The invention also relates to an aqueous composition comprising at least one difunctional compound T prepared according to the preparation method according to the invention.

Advantageously, the difunctional compound according to the invention is a compound having a hydrophilic character. It can be formulated in an aqueous medium.

The aqueous composition according to the invention may also comprise at least one additive, in particular an additive chosen among:
an amphiphilic compound, in particular a surfactant compound, preferably a hydroxylated surfactant compound, for example alkyl-polyalkylene glycol, in particular alkyl-polyethylene glycol and alkyl-polypropylene glycol;
a polysaccharide derivative, for example cyclodextrin, cyclodextrin derivative, polyethers, alkyl-glucosides;
solvents, in particular coalescing solvents, and hydrotropic compounds, for example glycol, butyl glycol, butyldiglycol, mono propylene glycol, ethylene glycol, ethylenediglycol, Dowanol products with CAS number 34590-94-8), Texanol products with CAS number 25265-77-4);
anti-foaming agents, biocides.

The invention also provides an aqueous formulation that can be used in many technical fields. The aqueous formulation according to the invention comprises at least one composition according to the invention and may comprise at least one organic or mineral pigment or organic, organo-metallic or mineral particles, for example calcium carbonate, talc, kaolin, mica, silicates, silica, metal oxides, in particular titanium dioxide, iron oxides. The aqueous formulation according to the invention can also comprise at least one agent chosen among a particle-spacer agent, a dispersing agent, a stabilising steric agent, an electrostatic stabilising agent, an opacifying agent, a solvent, a coalescing agent, an anti-foaming agent, a preservative agent, a biocide, a spreading agent, a thickening agent, a film-forming copolymer and mixtures thereof.

Depending on the particular difunctional compound or the additives that it comprises, the formulation according to the invention can be used in many technical fields. Thus, the formulation according to the invention can be a coating formulation. Preferably, the formulation according to the invention is an ink formulation, an adhesive formulation, a varnish formulation, a paint formulation, for example a decorative paint or an industrial paint. Preferably, the formulation according to the invention is a paint formulation.

The invention also provides a concentrated aqueous pigment pulp comprising at least one difunctional compound T according to the invention or at least one difunctional compound T prepared according to the preparation method according to the invention and at least one coloured organic or mineral pigment.

The difunctional compound according to the invention has properties that make it possible to use it to modify or control the rheology of the medium comprising it. Thus, the invention also provides a method for controlling the viscosity of an aqueous composition.

This viscosity control method according to the invention comprises the addition of at least one difunctional compound T according to the invention to an aqueous composition. This viscosity control method may also include the addition of at least one difunctional compound T prepared according to the preparation method according to the invention.

Preferably, the viscosity control method according to the invention is carried out using an aqueous composition according to the invention. Also preferably, the viscosity control method according to the invention is carried out using an aqueous formulation according to the invention.

The particular, advantageous or preferred characteristics of the difunctional compound T according to the invention define aqueous compositions according to the invention, formulations according to the invention, pigment pulp and viscosity control methods which are also particular, advantageous or preferred.

The following examples illustrate the various aspects of the invention.

### EXAMPLES

### Example 1: Preparation of Difunctional Compounds According to the Invention

### Example 1-1: Preparation of a Compound T1 According to the Invention

In a 3 L glass reactor equipped with mechanical stirring, a vacuum pump, a nitrogen inlet and heated by means of a double jacket in which oil circulates, 452.3 g of ethoxylated dodecanol are introduced with 140 mol of ethylene oxide (MM=6,355 Da) that is heated to 80° C. in an inert atmosphere. 5.69 g of sodium hydroxide are added and the medium is kept stirred for 2 hours.

6.18 g (MM=173.8 g/mol) of dibromomethane are then added in one hour. After the addition is completed, the reaction mixture is left to stir for 60 minutes at 100° C.±1° C. The compound T1 obtained is formulated in water with the addition of 1,000 ppm of a biocide (Biopol SMV Chemipol) and of 1,000 ppm of an anti-foaming agent (Tego 1488 Evonik). A composition 1 is obtained consisting of 20% by mass of compound T1 according to the invention and 80% by mass of water.

### Example 1-2: Preparation of a Compound T2 According to the Invention

In a 3 L glass reactor equipped with mechanical stirring, a vacuum pump, a nitrogen inlet and heated by means of a double jacket in which oil circulates, 451.0 g of ethoxylated tristyrylphenol are introduced with 130 mol of ethylene oxide (MM=6,120 Da) that is heated to 80° C. in an inert atmosphere. 5.90 g of sodium hydroxide are added and the medium is kept stirred for 2 hours.

6.40 g (MM=173.8 g/mol) of dibromomethane are then added in one hour. After the addition is completed, the reaction mixture is left to stir for 60 minutes at 100° C.±1° C. The compound T2 obtained is formulated in water with the addition of 1,000 ppm of a biocide (Biopol SMV Chemipol) and of 1,000 ppm of an anti-foaming agent (Tego 1488 Evonik). A composition 2 is obtained consisting of 20% by mass of compound T2 according to the invention and 80% by mass of water.

### Example 2: Preparation of Paint Formulations According to the Invention

A paint formulation F1 according to the invention is prepared from aqueous composition 1 of difunctional compound T1 according to the invention. All of the ingredients and proportions (% by mass) used are listed in Table 1.

TABLE 1

| Ingredients | Amount (g) |
|---|---|
| water | 99.7 |
| dispersing agent (Coadis BR3 Coatex) | 3.9 |
| biocide (Acticide MBS Thor) | 1.3 |
| anti-foaming agent (Airex 901W Evonik) | 1.31 |
| NH₄OH (28%) | 0.6 |
| TiO₂ pigment (RHD2 Huntsman) | 122.2 |
| CaCO₃ pigment (Omyacoat 850 OG Omya) | 84.6 |
| binding agent (Acronal S790 Basf) | 270.7 |
| monopropylene glycol | 6.5 |
| solvent (Texanol Eastman) | 6.5 |
| anti-foaming agent (Tego 825 Evonik) | 1.0 |
| aqueous composition 1 according to the invention | 28.7 |
| added water | q.s.p 650 g total |

### Example 3: Characterisation of Paint Formulations According to the Invention

For the paint formulation according to the invention, the Brookfield viscosity, measured at 25° C. and at 10 rpm and 100 rpm (μ_{Bk10} and μ_{Bk100} in mPa·s) was determined 24 hours after its preparation using a Brookfield DV-1 viscometer with RVT spindles. The properties of the paint formulation are listed in Table 2.

TABLE 2

| Formulation | Compound | μ_{BK10} | μ_{BK100} |
|---|---|---|---|
| F1 | T1 | 1,370 | 890 |

The difunctional compounds according to the invention are highly effective in obtaining excellent low and medium shear gradient viscosities for paint compositions.

### Example 4: Characterisation of Paint Formulations According to the Invention

For the paint formulation according to the invention, the Cone Plan viscosity or ICI viscosity, measured at high shear gradient (μI in mPa·s) was determined 24 hours after its preparation and at room temperature, using a Cone & Plate Research Equipment London (REL) viscometer with a measuring range of 0 to 5 poise, and the Stormer viscosity, measured at medium shear gradient (μS in Krebs Units or KUs), was determined using the reference module of a Brookfield KU-2 viscometer. The properties of the paint formulation are listed in Table 3.

TABLE 3

| Formulation | Compound | μI | μS | μI/μS |
|---|---|---|---|---|
| F1 | T1 | 170 | 81 | 2.1 |

The difunctional compounds according to the invention make it possible to prepare paint formulations with particularly well-controlled viscosities. In particular, the μ_{I} viscosity is particularly high and the μᵣ/μₛ ratio is therefore excellent. The compounds according to the invention allow for an excellent compromise between high shear gradient viscosity and low shear gradient viscosity.

1. A difunctional compound T prepared by reacting:
a. one molar equivalent of at least one dihalogenated compound (a) of formula (I):
L-R₂ (I)
wherein R independently represents Cl, Br or I and L independently represents a CH₂ group and
b. two molar equivalents of a same polyalkoxylated compound (b) selected from the group consisting of:
straight aliphatic monoalcohols (b1) comprising from 6 to 40 polyalkoxylated carbon atoms and comprising from 80 to 500 alkoxylated groups,
branched aliphatic monoalcohols (b2) comprising from 6 to 40 polyalkoxylated carbon atoms and comprising from 80 to 500 alkoxylated groups,
cycloaliphatic monoalcohols (b3) comprising from 6 to 40 polyalkoxylated carbon atoms and comprising from 80 to 500 alkoxylated groups,
monoaromatic monoalcohols (b4) comprising from 6 to 30 polyalkoxylated carbon atoms and comprising from 80 to 500 alkoxylated groups, and
polyaromatic monoalcohols (b5) comprising from 10 to 80 polyalkoxylated carbon atoms and comprising from 80 to 500 alkoxylated groups.

2. The difunctional compound T according to claim 1, comprising a single compound (a) or two or three different compounds (a).

3. The difunctional compound T according to claim 1, wherein dihalogenated compound (a) is a compound of formula (I) wherein R independently represents Br or I.

4. The difunctional compound T according to claim 3, wherein compound (a) is selected from the group consisting of dibromomethane, diiodomethane and combinations thereof.

5. The difunctional compound T according to claim 1:
wherein a degree of polyalkoxylation is between 100 and 502, or
wherein the polyalkoxylated compound (b) comprises from 100 to 500 alkoxylated groups, or
wherein the alkoxylated groups are selected from the group consisting of oxyethylene (—CH₂CH₂O—), oxypropylene (—CH₂CH(CH₃)O— or —CH(CH₃)CH₂O—), oxybutylene (—CH(CH₂CH₃)CH₂O— or —CH₂CH(CH₂CH₃)O—) and combinations thereof.

6. The difunctional compound T according to claim 1, wherein
a hydrocarbon chain of the straight aliphatic monoalcohol (b1) comprises from 6 to 30 carbon atoms,
a hydrocarbon chain of the branched aliphatic monoalcohol (b2) comprises from 6 to 30 carbon atoms, or
a hydrocarbon chain of the cycloaliphatic monoalcohol (b3) comprises from 6 to 30 carbon atoms, or
a hydrocarbon chain of the monoaromatic monoalcohol (b4) comprises from 12 to 30 carbon atoms or
a hydrocarbon chain of the polyaromatic monoalcohol (b5) comprises from 10 to 60 carbon atoms.

7. A method for preparing a difunctional compound T, comprising reacting:
a. one molar equivalent of at least one dihalogenated compound (a) of formula (I):
L-R₂ (I)
wherein R independently represents Cl, Br or I and L independently represents a CH₂ group and
b. two molar equivalents of a same polyalkoxylated compound (b) selected from the group consisting of:
straight aliphatic monoalcohols (b1) comprising from 6 to 40 polyalkoxylated carbon atoms and comprising from 80 to 500 alkoxylated groups,
branched aliphatic monoalcohols (b2) comprising from 6 to polyalkoxylated carbon atoms and comprising from 80 to 500 alkoxylated groups,
cycloaliphatic monoalcohols (b3) comprising from 6 to 40 polyalkoxylated carbon atoms and comprising from 80 to 500 alkoxylated groups,
monoaromatic monoalcohols (b4) comprising from 6 to 30 polyalkoxylated carbon atoms and comprising from 80 to 500 alkoxylated groups, and
polyaromatic monoalcohols (b5) comprising from 10 to 80 polyalkoxylated carbon atoms and comprising from 80 to 500 alkoxylated groups.

8. The method according to claim 7 wherein the reacting comprises a single compound (a) or two or three different compounds (a).

9. An aqueous composition comprising:
at least one difunctional compound T according to claim 1 and
at least one additive selected from the group consisting of
an amphiphilic compound,
a polysaccharide derivative,
a solvent,
an anti-foaming agent, and a biocide.

10. An aqueous formulation comprising:
at least one aqueous composition according to claim 9;
at least one organic or mineral pigment or organic, organo-metallic or mineral particles, and
at least one agent selected from the group consisting of a particle-spacer agent, a dispersing agent, a stabilising steric agent, an electrostatic stabilising agent, an opacifying agent, a solvent, a coalescing agent, an anti-foaming agent, a preservative agent, a biocide, a spreading agent, a thickening agent, a film-forming copolymer and mixtures thereof.

11. The aqueous formulation according to claim 10, wherein the aqueous formulation is an ink formulation, a varnish formulation, an adhesive formulation, or a paint formulation.

12. A concentrated aqueous pigment pulp comprising at least one difunctional compound T according to claim 1 and at least one coloured organic or mineral pigment.

13. A method for controlling a viscosity of an aqueous composition comprising adding at least one difunctional compound T according to claim 1 to the aqueous composition.

14. A method for controlling a viscosity of the aqueous composition according to claim 9, comprising adding the at least one difunctional compound T to the aqueous composition.
